(19) United States
(12) Patent Application Publication
(10) Pub. No.: US 2008/0101739 A1
(43) Pub. Date: May 1, 2008

(54) Fluid dynamic bearing system and a spindle motor having a bearing system of this kind

(76) Inventors: Matthias Wildpreth, Villingen-Schwenningen (DE); Andreas Kull, Donaueschingen (DE); Martin Hafen, Spaichingen (DE); Olaf Winterhalter, Epfendorf (DE); Thilo Rehm, Villingen-Schwenningen (DE)

Correspondence Address: COOPER & DUNHAM, LLP, 1185 AVENUE OF THE AMERICAS, NEW YORK, NY, 10036, US

(21) Appl. No.: 11/975,431

(22) Filed: Oct. 19, 2007

(30) Foreign Application Priority Data
Oct. 30, 2006 (DE) 10 2006 051 716.4
Jul. 13, 2007 (DE) 10 2007 032 673.6

(51) Int. Cl. H02K 5/167; F16C 32/06; H02K 9/06; G11B 17/08

(52) U.S. Cl. 384/110; 310/62; 310/90; 360/98.07

(57) ABSTRACT

The invention relates to a fluid dynamic bearing system having at least one stationary (10) and at least one moving bearing part (22) that are rotatable about a common rotational axis (16) with respect to one another and form a bearing gap (14) filled with a bearing fluid between associated bearing surfaces, wherein a sealing gap (38) adjoins one end of the bearing gap, the sealing gap being disposed between a sleeve surface (40) of the stationary bearing part (10) and an opposing sleeve surface (42) of the moving bearing part (22) and comprising a radial section and an axial section and being at least partially filled with bearing fluid, wherein in the region of the axial section of the sealing gap (38), the sleeve surface (40) of the stationary bearing part (10) forms an acute angle a with the rotational axis (16) and the sleeve surface (42) of the moving bearing part (12, 22) forms an acute angle β with the rotational axis (16), wherein for the angles the condition α≧β>0° applies, and the difference B₂ between the smallest radius r₂ of the sleeve surface (42) of the moving bearing part (22) adjacent to the sealing gap (38) and the largest radius r₁ of the sleeve surface (40) of the stationary bearing part (10) adjacent to the sealing gap (38) is less than or equal to the smallest width B₁ of the axial section of the sealing gap (38), and that B1≦2 B₂ further applies.

### BACKGROUND OF THE INVENTION

The invention relates to a fluid dynamic bearing system having the characteristics outlined in the preamble of claim 1. These kinds of fluid dynamic bearing systems are used, for example, to rotatably support fans or spindle motors, which in turn are used for driving hard disk drives or suchlike.

### PRIOR ART

Fluid dynamic bearings as employed in spindle motors generally comprise at least two bearing parts that are rotatable with respect to each other and form a bearing gap filled with a bearing fluid, e.g. air or bearing oil, between bearing surfaces associated with each other. Surface patterns that are associated with the bearing surfaces and that act on the bearing fluid are provided using a well-know method. In fluid dynamic bearings, the surface patterns taking the form of depressions or raised areas are usually formed on one or both bearing surfaces. These patterns formed on the appropriate bearing surfaces of the bearing partners act as bearing and/or pumping patterns that generate hydrodynamic pressure within the bearing gap when the bearing parts rotate with respect to each other. In the case of radial bearings, sinoid, parabolic or herringbone surface patterns, for example, are used that are distributed perpendicular to the rotational axis of the bearing parts over the circumference of at least one bearing part. In the case of axial bearings, spiral-shaped or herringbone surface patterns, for example, are used which are mainly distributed perpendicular about a rotational axis. According to a well-known design of a fluid dynamic bearing for a spindle motor for driving hard disk drives, a shaft is rotatably supported in a bore in a bearing bush. The diameter of the bore is slightly larger than the diameter of the shaft so that a bearing gap filled with a bearing fluid remains between the surfaces of the bearing bush and the shaft. The surfaces facing each other of the shaft and/or the bearing bush have pressure-generating bearing patterns forming part of at least one fluid dynamic radial bearing. A free end of the shaft is connected to a hub whose lower surface, together with an end face of the bearing bush forms a fluid dynamic axial bearing. For this purpose, one of the facing surfaces of the hub or the bearing bush is provided with pressure-generating bearing patterns.

In constructing fluid dynamic bearing systems for application in spindle motors it is necessary to ensure that preferably no bearing fluid can leak out of the bearing gap into other regions of the spindle motor. On the one hand, any leakage of bearing fluid from the bearing gap will reduce the useful life of the bearing system since this brings with it the risk, for example, of the bearing running dry, and on the other hand leaking bearing fluid will soil other components of the spindle motor. Leakage of bearing fluid from the bearing gap is consequently prevented by using appropriate sealing arrangements. Capillary seals find frequent application here, the capillary seals adjoining the open end of the bearing gap and preventing bearing fluid from leaking into the motor. The bearing fluid is held in the capillary seal by means of capillary forces, a vapor barrier being also formed in the sealing gap through evaporating bearing fluid at the interface between the bearing fluid and the air found in the capillary seal.

The bearing fluid found in the sealing gap also often acts as a lubricant reservoir from which evaporated bearing oil is replaced. The part of the sealing gap that is not filled with bearing oil serves as an equalizing volume in which the bearing fluid can expand when its temperature-dependent volume increases as the temperature rises, thus causing the fluid level to change. The bearing gap and the sealing gap are filled with an exact amount of bearing fluid. It is then necessary to check the filling height of the bearing fluid in the sealing gap. However, it is difficult to find a fast and easy way of ascertaining the filling level of the bearing fluid in the sealing gap since it is often not possible to see into the sealing gap at all, or only part of the way into it. In U.S. Pat. No. 7,118,278 B2 the bearing fluid cannot be detected when the oil level is low. Moreover, in this case a separate component is required that is fixed to the hub and forms the outer circumference of the capillary seal.

### SUMMARY OF THE INVENTION

It is thus the object of the invention to provide a fluid dynamic bearing system in which the filling level of the bearing fluid can be quickly arid easily ascertained. In addition, the bearing system should have a long service life as well as good shock resistance and retaining ability for the bearing fluid in the bearing gap.

This object has been achieved according to the invention by a bearing system having the characteristics outlined in patent claim 1.

Preferred embodiments and other beneficial characteristics of the invention are cited in the subordinate claims.

The fluid dynamic bearing system comprises at least one stationary and at least one moving bearing part that are rotatable about a common rotational axis with respect to one another and form a bearing gap filled with a bearing fluid between associated bearing surfaces. A sealing gap adjoins one end of the bearing gap, the sealing gap being disposed between a sleeve surface of the stationary bearing part and an opposing sleeve surface of the moving bearing part and comprising a radial section and an axial section and being at least partially filled with bearing fluid. In the region of the axial section of the sealing gap, the sleeve surface of the stationary bearing part forms an acute angle α with the rotational axis and the sleeve surface of the moving bearing part forms an acute angle β with the rotational axis.

According to the invention, it is provided that α≧β>0° and that the difference B₂ between the smallest radius r₂ of the sleeve surface of the moving bearing part adjacent to the sealing gap and the largest radius r₁ of the sleeve surface of the stationary bearing part adjacent to the sealing gap is less than or equal to the smallest width B₁ of the axial section of the sealing gap, which corresponds to the smallest distance between the outside diameter of the bearing bush and the inner wall of the hub.

To ensure that the filling level of the fluid in the sealing gap can be seen in a direction of sight parallel to the rotational axis over the entire length of the axial section of the sealing gap up to the level of the axial bearing, the amount B₁ has to be less than or equal to twice the amount B₂.

To minimize the leakage and also the evaporation of bearing fluid in the region of the capillary seal, the sealing gap is very narrow although it is one or two magnitudes larger than the dimensions of the bearing gap. Another aim is to make the sealing gap very long, making it possible on the one hand to introduce an appropriate supply of bearing fluid into the sealing gap and on the other hand to increase the length of the vapor barrier.

Thus according to the invention, a sealing gap is provided that extends over a part of the outside circumference of the stationary bearing part and which preferably has a very small width. The small width and the relative length of the sealing gap result in a lower evaporation rate of the bearing fluid found in the sealing gap, which goes to ensure a longer useful life for the fluid dynamic bearing system. Moreover, the small width of the bearing gap goes to improve the shock behavior of the bearing, since even under comparatively large axial shocks acting on the bearing, no bearing fluid can leak from the sealing gap.

The two angles α and β can be chosen from a preferred range of between 0° and 10°, angle α preferably being larger than angle β. This results in the sealing gap widening conically in the direction of its open end and, alongside the sealing effect of the sealing gap due to capillary effects, there is a further effect intensifying the sealing effect which is based on centrifugal forces exerted on the bearing fluid when the bearing parts are in rotation. The bearing fluid is accelerated radially outwards by the centrifugal force. The more strongly slanted sleeve surface of the bearing bush means that the bearing fluid is forced in the opposite direction towards the opening of the sealing gap and pressed into the sealing gap due to the active centrifugal forces. This provides an added guarantee against leakage of bearing fluid from the sealing gap. Furthermore, the capillary seal that widens axially downwards almost continuously facilitates the outward release of emissive air from within the bearing fluid into the atmosphere. This effectively stops air from gathering in the region of the upper axial bearing in particular. This is important to the extent that air gathering in the region of the bearing patterns can lead to bearing failure.

The embodiment of the sealing gap according to the invention makes it possible to optically determine the filling level of the bearing fluid in the sealing gap with precision even at a comparatively low fluid level. For example, when the bearing is being filled with bearing fluid and the filling level is too low in relation to the specifications, the amount of bearing fluid that is still missing can be accurately determined and an extra amount of bearing fluid can be filled into the bearing in a second filling operation. This makes it possible to keep to the overall quantity of fluid specified without there being too much or too little fluid in the bearing. This makes it unnecessary to either carry out any further checks on the filling level or to top up with bearing fluid or even to draw off or remove bearing fluid.

Moreover, even after the bearing has been operating for a long period of time, for example, when a return is being inspected, it is still possible without any problem at all to optically determine from the outside whether there is still enough bearing fluid in the bearing. Furthermore, there is also the possibility during tests for useful life of repeatedly taking interim measurements of the fluid level. This makes it possible to accurately ascertain the evaporation rates of bearing fluid for specific motor designs at varying rotational speeds of the spindle motor and at different temperatures as well.

For this purpose, the axial position of the apex, i.e. the highest axial point of the fluid meniscus, is determined, for instance, using a chromatic sensor or a microscope, in a line of sight largely parallel to the rotational axis. Since the fluid meniscus acts like a concave mirror, depending on the optical aperture of the measuring instrument, the only light detected is that which strikes the fluid surface and is reflected at a short lateral distance to the apex.

In a preferred embodiment of the invention, the stationary bearing part comprises a bearing bush having a central bore and the moving bearing part comprises a shaft rotatably supported in the bore and a hub that is connected to the free end of the shaft and partly encloses the bearing bush while at the same time forming the sealing gap.

Using a well-known method, pressure-generating surface patterns are formed on the walls of the central bore and/or on the surface of the shaft, forming a part of at least one fluid dynamic radial bearing. Pressure-generating surface patterns are likewise formed on the end face of the bearing bush and/or a surface of the cup-shaped component located opposite this end face as part of a fluid dynamic axial bearing.

The sealing gap starts radially outside the axial bearing and then continues in an axial direction along the outside surface of the bearing bush. The axial length of the sealing gap, for example, is one third the length of the bearing bush.

The invention relates in particular to a fluid dynamic bearing system for a spindle motor as can be used for driving hard disk drives.

The invention will now be explained in more detail on the basis of a preferred embodiment with reference to the drawings described below. Further characteristics, advantages and possible applications of the invention can be derived from this.

### BRIEF DESCRIPTION OF THE DRAWINGS

FIG. 1: shows a longitudinal view through a spindle motor having a fluid dynamic bearing according to the invention.

FIG. 2: shows a detail of the spindle motor according to FIG. 1.

FIG. 3: shows a view of the sealing gap in an enlarged detail from FIGS. 1 or 2.

FIG. 4: shows a view of a bearing system in the region of the sealing gap similar to FIG. 2 but not according to the invention.

### DESCRIPTION OF A PREFERRED EMBODIMENT OF THE INVENTION

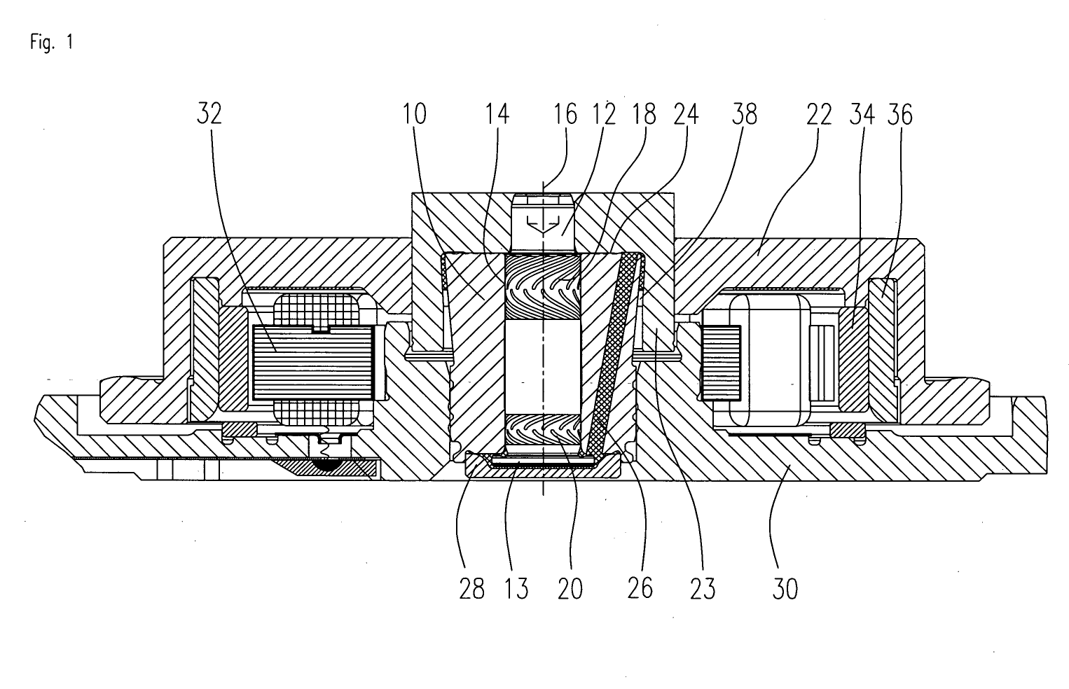

FIGS. 1 to 3 show sections through a spindle motor having a fluid dynamic bearing system according to the invention in different detailed views. The spindle motor comprises a stationary bearing bush 10 that has a central bore and forms the stationary part of the bearing system. A shaft 12 is inserted into the bore in the bearing bush 10, the diameter of the shaft 12 being slightly smaller than the diameter of the bore. A bearing gap 14 remains between the surfaces of the bearing bush 10 and the shaft 12. The surfaces facing each other of the shaft 12 and the bearing bush 10 form two fluid dynamic radial bearings 18, 20 by means of which the shaft 12 is rotatably supported about a rotational axis 16 in the bearing bush 10. The radial bearings 18, 20 are marked by bearing patterns that are formed on the surface of the shaft 12 and/or the bearing bush 10. The bearing gap 14 is filled with a suitable bearing fluid, such as a bearing oil. On rotation of the shaft 12, the bearing patterns exert a pumping effect on the bearing fluid found in the bearing gap 14 between the shaft 12 and the bearing bush 10, giving the radial bearings 18, 20 their load-carrying capacity.

A stopper ring 13 formed integrally with the shaft or as a separate part is disposed at the lower end of the shaft 12, the stopper ring 13 having an increased outside diameter compared to the diameter of the shaft. The stopper ring 13 prevents the shaft 12 from falling out of the bearing bush 10. The bearing is sealed at this end of the bearing bush 10 by a cover plate 28.

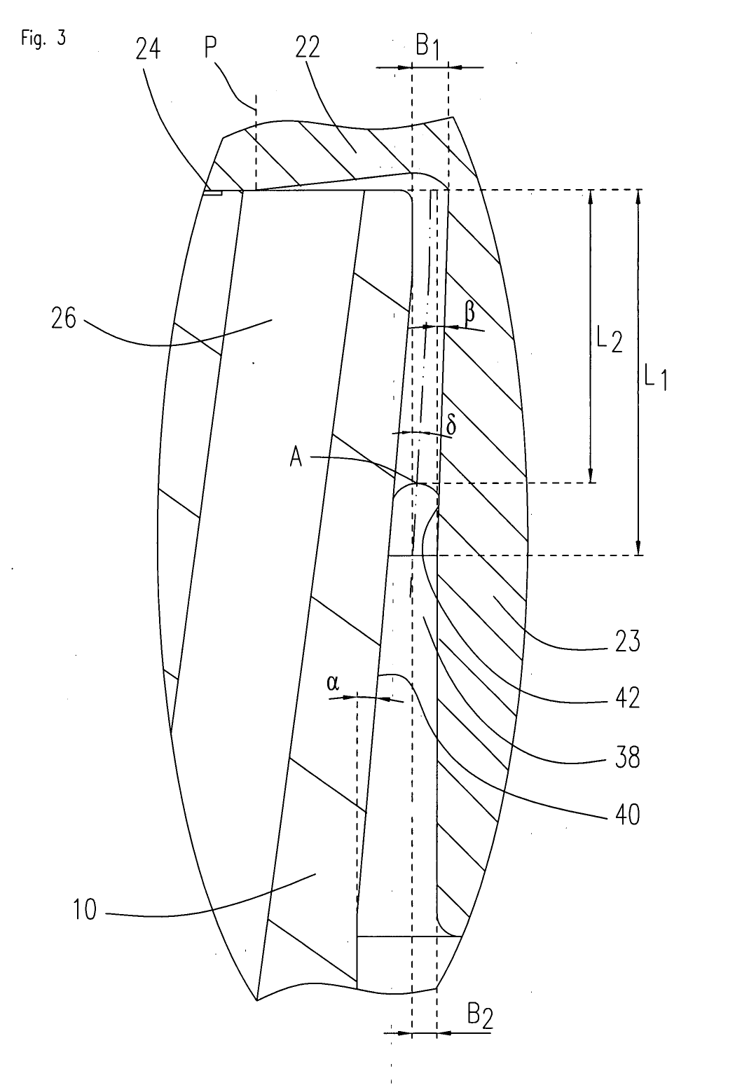

A free end of the shaft 12 is connected to a cup-shaped hub 22 that has an annular rim 23 that partly encloses the bearing bush. A lower, level face of the hub 22, together with an end face of the bearing bush 10, forms a fluid dynamic axial bearing 24. Here, the end face of the bearing bush 10 or the opposing face of the hub 22 is provided with bearing patterns which, on rotation of the shaft 12, exerts a pumping action on the bearing fluid found in the bearing gap 14 between the hub 22 and the end face of the bearing bush 10, giving the axial bearing 24 its load-carrying capacity. A recirculation channel 26 may be provided in the bearing bush 10, the recirculation channel 26 connecting a section of the bearing gap 14 located at the outer edge of the axial bearing 24 to a section of the bearing gap 14 located below the lower radial bearing 18 and aiding the circulation of the bearing fluid in the bearing. The pumping patterns of the axial bearing 24 preferably extend in a radial direction to at least the point in FIG. 3 indicated by P, most preferably, however, to the radially outer edge of the bearing bush 10. The pumping patterns of the axial bearing 24 may be disposed on the underside of the hub 22 or on the opposing topside of the bearing bush 10.

The bearing bush 10 is disposed in a baseplate 30 of the spindle motor. A stator arrangement 32 enclosing the bearing bush 10 is disposed on the baseplate 30, the stator arrangement 32 consisting of a ferromagnetic stack of laminations as well as stator windings. This stator arrangement 32 is enclosed by an annular rotor magnet 34 that is disposed in a back yoke ring 36 having a larger diameter and fixed at the inside circumference of an outer edge of the hub 22. An outer rotor motor is illustrated. It is clear that as an alternative an inner rotor motor could find application.

The bearing gap 14 comprises a section running in an axial direction that extends along the shaft 10 and the radial bearings 18, 20 and a section running in a radial direction that extends along the end face of the bearing bush 10 and the axial bearing 24. At the radially outer end of the radial section, the bearing gap 14 merges into a gap having a larger gap spacing that forms the radial section of a sealing gap 38. Starting at the bearing gap 14, the sealing gap 38 extends radially outwards and merges into an axial section that extends along the outside circumference of the bearing bush 10 between the bearing bush 10 and a rim of the hub 22. With a bearing bush 10 diameter of several millimetres, the width of the sealing gap 38 is typically 100-300 micrometers.

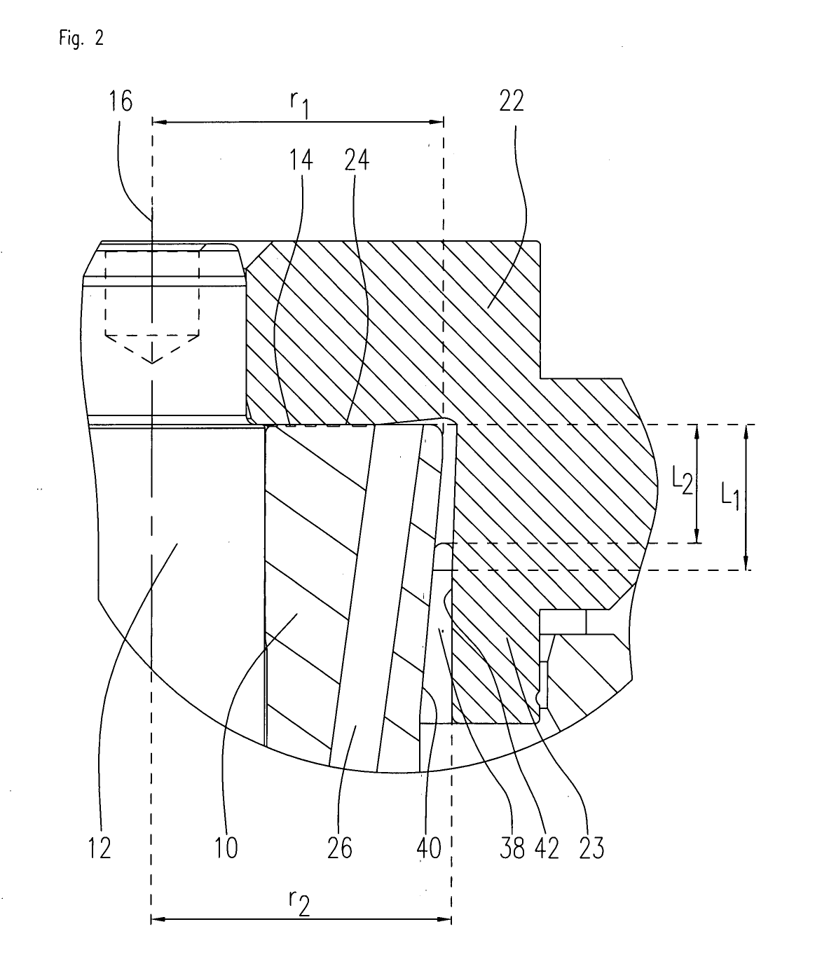

FIGS. 2 and 3 show enlarged views of the sealing gap 38 of the spindle motor of FIG. 1. It can be seen that an outer axial sleeve surface 40 of the bearing bush 10 as well as an inner axial sleeve surface 42 of the rim 23 of the hub 22 form the boundaries of the sealing gap 38. The two sleeve surfaces 40 and 42 do not run parallel but rather slant at an acute angle to the rotational axis 16. The angle α between the sleeve surface 40 of the bearing bush 10 and the rotational axis 16 is greater than 0° and is 5° for example. The peak of angle a lies in the region where the axial section of the sealing gap 38 starts, i.e. approximately at the level of axial bearing 24, angle α opening out towards the opening of the sealing gap 38. Angle β between the sleeve surface 42 of the rim 23 of the hub 22 and the rotational axis 16 is likewise greater than 0° and is 3° for example. The peak of angle β lies in the region where the axial section of the sealing gap 38 starts, angle β opening out towards the opening of the sealing gap 38. When the bearing is in operation, the bearing fluid is accelerated radially outwards seen from the rotational axis 16 and forced into the sealing gap 38 due to the steeper slant to the inner sleeve surface 40 of the bearing bush 10 compared to the outer sleeve surface 42, and held in the gap. Alongside the active capillary forces, this produces an additional sealing effect during dynamic operation of the bearing.

To be able to put the rim 23 of the hub 22 over the bearing bush 10 during assembly of the bearing system, the largest radius r₁ of the bearing bush 10 has to be smaller in the region of the sealing gap 38 than the smallest radius r₂ of the rim 23 of the hub 22 in the region of the sealing gap 38. The difference between the radii r₂ and r₁ is indicated by the width B₂. There is normally no bearing fluid in the part of the sealing gap 38 that is adjacent to the lower section of the rim 23 of the hub 22. Consequently, this region of the sleeve surface 42 may also be slanted or—as shown in FIG. 2—run parallel to the rotational axis 16.

The axial section of the sealing gap 38 is filled with bearing fluid starting from its smallest width B₁ over a length L₂. Due to the capillary effect, the contact surface between the bearing fluid and air forms a meniscus whose apex A (lowest point) defines the filling level of the bearing or respectively the filling level of the bearing fluid in the axial section of the sealing gap 38. To be able to optically determine the filling level of the bearing fluid in the axial section of the sealing gap 38 quickly and reliably, it is necessary for the apex A of the meniscus to be visible over at least an axial length L, of the sealing gap 38 up to the level of the axial bearing 24, when one looks into the sealing gap 38 parallel to the rotational axis 16 from the open end of the sealing gap 38. Calculations have shown that for small angles α, β, the apex A of the fluid meniscus is positioned in good approximation to the bisector within the sealing gap 38.

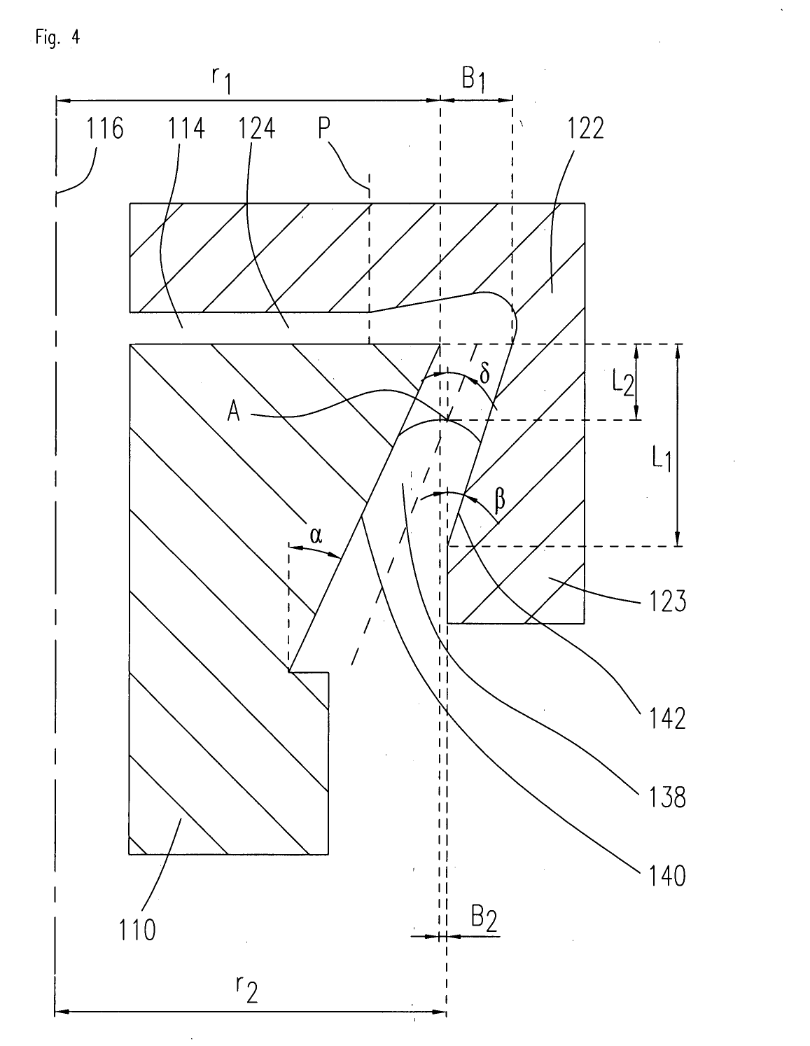

With reference to FIG. 4, the following equations apply:

$${L}_{1} = \frac{{B}_{1} - {B}_{2}}{tan β} und {L}_{2} = \frac{\frac{{B}_{1}}{2} - {B}_{2}}{tan δ} mit δ = \frac{α + β}{2} .$$

The condition for apex A of the meniscus to always be visible within the sealing gap 38 is:

B₁≦2 B₂

Since B₂ is less than B₁, this results in the concluding condition:

B₂≦B₁≦2 B₂

Another characteristic of the bearing for the purpose of reducing the bearing friction and thus the required energy consumption of the electric drive motor lies in the fact that already from a position P before the outside edge of the bearing bush 10, the bearing gap 14 continually opens up and widens into the sealing gap 38. This section of the sealing gap 38 is horizontal, i.e. disposed radially, and it then merges into a largely vertical, i.e. axial section, of the sealing gap 38. The axial section of the sealing gap 38 is defined by the bearing bush 10 and the rim 23 of the hub 22. Due to the preferred angle condition α>β, the cross-section of the axial section of the sealing gap 38 continues to widen in a radial direction. The same applies to the radial section of the sealing gap from a position P. The design of the sealing gap 38 as described above leads to a reduction in bearing friction and also makes possible the supply of a large enough volume of bearing fluid to ensure the useful life of the bearing. The largely conical opening of the sealing gap 38 ensures that the bearing is well sealed due to the capillary effect of the fluid in the sealing gap, so that even when subject to shocks, no bearing fluid can escape from the bearing.

In the upper axial region of the radially outer sleeve surface 40 of the bearing bush 10, there is a short section that runs parallel to the rotational axis of the bearing. This section may also be omitted and is only used for measuring the outside diameter of the bearing bush.

Compared to FIGS. 2 and 3, FIG. 4 shows an enlarged view of a sealing gap 138 of a fluid dynamic bearing whose design is not in accordance with the invention. However, the bearing is very similar to the bearing shown in FIGS. 1 to 3. Thus identical components or components having the same function as those in FIGS. 1 to 3 are indicated by the same reference numbers in FIG. 4, preceded, however, by a “1”. As can be seen from FIG. 4, the outer axial sleeve surface 140 of the bearing bush 110 as well as the inner axial sleeve surface 142 of the rim 123 of the hub 122 form the boundaries of the sealing gap 138. The two sleeve surfaces 140 and 142 do not run parallel to the rotational axis 116 but rather slant at an acute angle to it. In FIG. 4, the angles are exaggerated for the sake of clarity.

The largest radius r₁ of the bearing bush 110 that lies in the region of the sealing gap 138 is again smaller than the smallest radius r₂ of the rim 123 of the hub 122 in the region of the sealing gap 138. The difference between the radii r₂ and r₁ is indicated by the width B₂.

Starting from its smallest width B₁, the axial section of the sealing gap 138 is filled with bearing fluid over a length L₂. Due to the capillary effect, the contact surface between the bearing fluid and the air forms a meniscus whose apex A (lowest point) defines the filling level of the bearing or respectively the filling level of the bearing fluid in the axial section of the sealing gap 138.

To be able to optically determine the filling level of the bearing fluid in the axial section of the sealing gap 138 quickly and reliably, it is important for the apex A of the meniscus to be visible over the entire axial length L₁ of the sealing gap 138 up to the level of the axial bearing 124, if one looks into the sealing gap 138 parallel to the rotational axis 116 from the open end of the sealing gap 138. It is of course clear that optical measuring instruments such as a microscope, a CCD camera, a white light interferometer or a chromatic sensor may be used to determine the filling height. According to the invention, the condition for the apex A of the meniscus within the sealing gap 138 to always remain visible is:

B₁≦2 B₂

This condition is not met in FIG. 4. The filling level of the fluid shown in FIG. 4 can only just be distinguished. It would not be possible to detect lower filling levels since apex A of the fluid meniscus would be hidden by the lower rim 123 of the hub 122.

### IDENTIFICATION REFERENCE LIST

10 Bearing bush

12 Shaft

13 Stopper ring

14 Bearing gap

16 Rotational axis

18 Radial bearing

20 Radial bearing

22 Hub

23 Rim of the hub

24 Axial bearing

26 Recirculation channel

28 Cover plate

30 Baseplate

32 Stator arrangement

34 Rotor magnet

36 Back yoke ring

38 Sealing gap

40 Sleeve surface (stationary bearing part)

42 Sleeve surface (moving bearing part)

110 Bearing bush

114 Bearing gap

116 Rotational axis

122 Hub

123 Rim of the hub

124 Axial bearing

138 Sealing gap

140 Sleeve surface (stationary bearing part)

142 Sleeve surface (moving bearing part)

A Apex

P Position

1. A fluid dynamic bearing system having at least one stationary (10) and at least one moving bearing part (12, 22) that are rotatable about a common rotational axis (16) with respect to one another and form a bearing gap (14) filled with a bearing fluid between associated bearing surfaces, wherein a sealing gap (38) adjoins one end of the bearing gap, the sealing gap being disposed between a sleeve surface (40) of the stationary bearing part (10) and an opposing sleeve surface (42) of the moving bearing part (12, 22) and comprising a radial section and an axial section and being at least partially filled with bearing fluid, wherein in the region of the axial section of the sealing gap (38), the sleeve surface (40) of the stationary bearing part (10) forms an acute angle α with the rotational axis (16) and the sleeve surface (42) of the moving bearing part (12, 22) forms an acute angle β with the rotational axis (16),
characterized in that
for the angles α and β the condition α≧β>0° applies,
the difference B₂ between the smallest radius r₂ of the sleeve surface (42) of the moving bearing part (22) adjacent to the sealing gap (38) and the largest radius r₁ of the sleeve surface (40) of the stationary bearing part (10) adjacent to the sealing gap (38) is less than or equal to the smallest width B₁ of the axial section of the sealing gap (38),
and that B₁≦2 B₂ further applies, so that the filling level of the bearing fluid can be optically determined in the entire axial section of the sealing gap (38).

2. A fluid dynamic bearing system according to claim 1, characterized in that
α>β.

3. A fluid dynamic bearing system according to claim 1, characterized in that the angle α lies between 0° and 10°.

4. A fluid dynamic bearing system according to claim 1, characterized in that the angle β lies between 0° and 10°.

5. A fluid dynamic bearing system according to claim 1, characterized in that the sealing gap (38) together with the bearing fluid found in the gap forms a capillary seal.

6. A fluid dynamic bearing system according to claim 1, characterized in that the stationary part comprises a bearing bush (10) having a central bore.

7. A fluid dynamic bearing system according to claim 1, characterized in that the moving bearing part comprises a shaft (12) that is rotatably supported in the bore whose free end is connected to a hub (22), the hub partly enclosing the bearing bush (10) while forming the sealing gap (38).

8. A fluid dynamic bearing system according to claim 6, characterized in that pressure-generating patterns are formed on the walls of the central bore and/or on the surface of the shaft (12) forming a part of at least one fluid dynamic radial bearing (18; 20).

9. A fluid dynamic bearing system according to claim 7, characterized in that pressure-generating patterns are formed on an end face of the bearing bush (10) and/or a surface of the hub (22) opposing this end face, forming part of a fluid dynamic axial bearing (24).

10. A spindle motor having a fluid dynamic bearing system according to claim 1, further comprising a baseplate to receive the stationary bearing part (10) of the bearing system and an electromagnetic drive system (40; 42; 44) to drive the moving bearing part (12; 22).

11. A hard disk drive having a spindle motor according to claim 10 to rotationally drive at least one magnetic storage disk as well as a read/write device to read and write data from or onto the magnetic storage disk.

12. A fan having a spindle motor according to claim 10 to drive a fan wheel.
